(19) United States
(12) Patent Application Publication
(10) Pub. No.: US 2014/0013255 A1
(43) Pub. Date: Jan. 9, 2014

(54) OBJECT DISPLAY CONTROL APPARATUS AND OBJECT DISPLAY CONTROL METHOD

(71) Applicant: CANON KABUSHIKI KAISHA, Tokyo (JP)

(72) Inventors: Yuko Fukuoka, Kawasaki-shi (JP); Keiichi Ando, Tokyo (JP)

(21) Appl. No.: 13/934,123

(22) Filed: Jul. 2, 2013

(30) Foreign Application Priority Data
Jul. 9, 2012 (JP) 2012-153675

(51) Int. Cl. G06F 3/0484

(52) U.S. Cl. CPC G06F 3/0484
USPC 715/765

(57) ABSTRACT

An apparatus includes a moving unit configured to move an object group including a plurality of objects within a predetermined area of a display apparatus, and a control unit configured to display in the predetermined area, the objects included in the object group, wherein the control unit changes a shape of the object group so that the objects displayed outside the predetermined area can be displayed within the predetermined area, in a case where one or more objects displayed within the predetermined area are placed outside the predetermined area when the moving unit moves the object group.

### BACKGROUND

1. Field of the Disclosure

Aspects of the present invention generally relate to an apparatus which displays predetermined objects on a display apparatus, and a method thereof.

2. Description of the Related Art

Conventionally, a user is capable of arranging in an arbitrary position on a display screen of a display apparatus an object group including a plurality of objects such as images or icons (e.g., a short cut menu) to free up a workspace on the display screen. However, if the number of objects in the object group increases, the size of the object group increases, so that the user cannot free up a sufficient working area.

To solve such a problem, Japanese Patent No. 2968523 discusses an information processing apparatus which reduces a display size of all or a portion of the icons in a tool box that includes a plurality of icons. Further, Japanese Patent No. 4788344 discusses a method for displaying a task bar as follows. If the task bar including an item group is moved within a predetermined area on a desktop, only the item among the target objects which includes a function corresponding to the display area is displayed on the task bar, and the items that are not usable are not displayed.

However, if the size of the object in the object group is reduced as discussed in Japanese Patent No. 2968523, it becomes difficult for the user to view the object. On the other hand, if the objects are not displayed as discussed in Japanese Patent No. 4788344, operability is degraded.

### SUMMARY

According to an aspect of the present invention, an apparatus includes a moving unit configured to move an object group including a plurality of objects within a predetermined area of a display apparatus, a control unit configured to display within the predetermined area, the objects included in the object group, wherein the control unit changes a shape of the object group so that the objects displayed outside the predetermined area can be displayed within the predetermined area, in a case where one or more objects displayed within the predetermined area are placed outside the predetermined area when the moving unit moves the object group.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a display control apparatus according to a first exemplary embodiment.

FIG. 2 illustrates an object group displayed on a display screen of a display apparatus according to the first exemplary embodiment.

FIG. 3 illustrates a software configuration of the display control apparatus according to the first exemplary embodiment.

FIG. 4 illustrates the object group displayed on the display screen of the display apparatus according to the first exemplary embodiment.

FIG. 5 is a flowchart illustrating control performed by the display control apparatus according to the first exemplary embodiment.

FIG. 6 illustrates an object group displayed on a display screen of a display apparatus according to a second exemplary embodiment.

FIG. 7 illustrates an object group displayed on a display screen of a display apparatus according to a third exemplary embodiment.

FIG. 8 illustrates an object group displayed on a display screen of a display apparatus according to a fourth exemplary embodiment.

FIG. 9 illustrates an object group displayed on a display screen of a display apparatus according to a fifth exemplary embodiment.

### DESCRIPTION OF THE EMBODIMENTS

Various exemplary embodiments, features, and aspects of the invention will be described in detail below with reference to the drawings.

The scope of the claims is not limited to the exemplary embodiments to be described below.

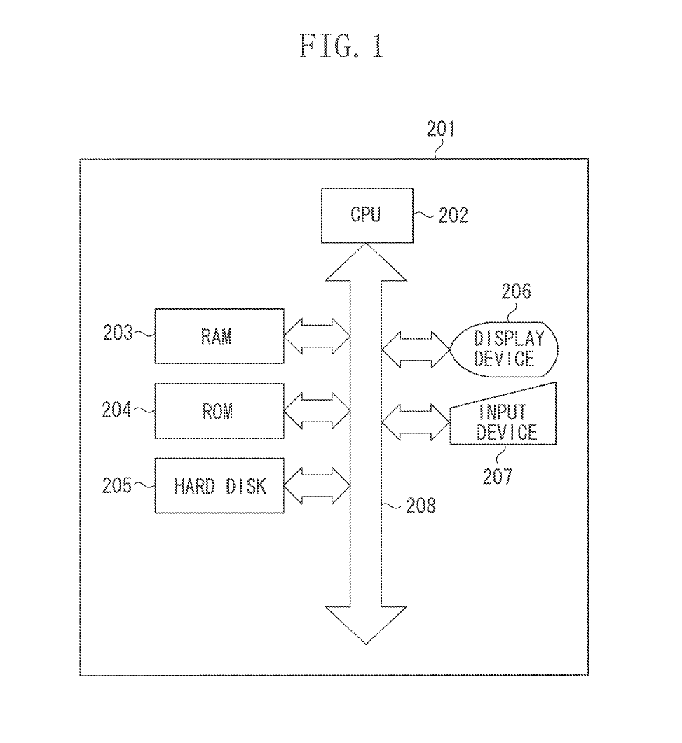

FIG. 1 is a block diagram illustrating an example of a configuration of the display control apparatus according to the first exemplary embodiment.

Referring to FIG. 1, a display control apparatus 201 includes a central processing unit (CPU) 202, a random access memory (RAM) 203, a read-only memory (ROM) 204, a hard disk 205, i.e., a storing device, a display device 206, and an input device 207, which are connected via a system bus 208. The display control apparatus 201 may be a personal computer (PC) or a smartphone.

The CPU 202 is a central processing unit which collectively controls each unit in the display control apparatus 201 by executing programs such as an operating system (OS), application software, and a device driver. The CPU 202 calculates, determines, and controls data and commands according to the programs stored in the RAM 203, the ROM 204, and the hard disk 205.

The RAM 203 is used as the work area of the CPU 202 and a temporary storage area when the CPU 202 performs various types of processing. The ROM 204 is a memory storing a boot program. The hard disk 205 is a fixed memory unit which stores the OS and the application software.

The display device 206 such as a cathode ray tube (CRT) display or a liquid crystal display displays a graphical user interface (GUI) based on control performed by the CPU 202. The object group listing a plurality of objects is displayed on the GUI.

The input device 207 such as a mouse or a keyboard is used by the user to issue various instructions to the display control apparatus 201. Further, the input device 207 may be integrated with the display device 206 as a touch panel.

The system bus 208 is used for exchanging data between the CPU 202, the RAM 203, the ROM 204, and the hard disk 205.

According to the present exemplary embodiment, the display control apparatus 201 is an apparatus in which the display device 206 and the input device 207 are integrated with a control unit including the CPU 202 and the RAM 203. However, the display control apparatus is not limited thereto. For example, the display device and the input device may be separate devices in the display control apparatus 201.

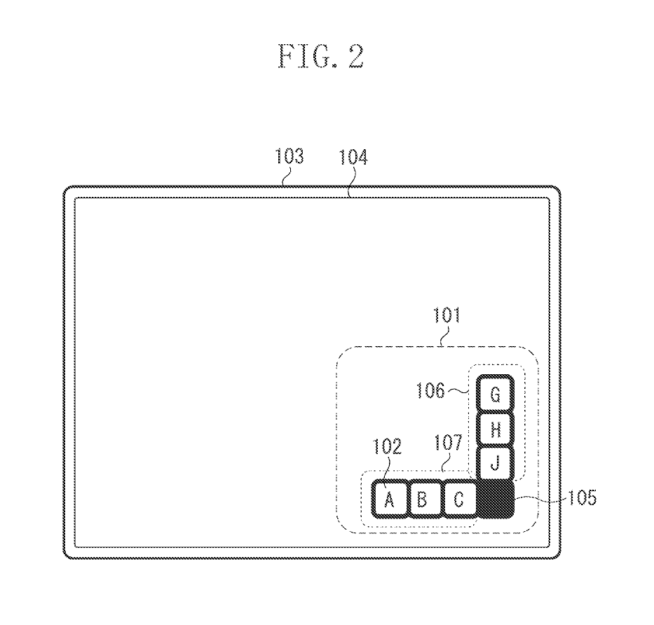

Displaying of the object group on the display device 206 illustrated in FIG. 1 will be described below with reference to FIG. 2.

Referring to FIG. 2, an object group 101 is displayed on a display screen 103 which is an area for displaying images and characters in the display device 206. The object group 101 is a collection in which a plurality of objects 102 such as characters, icons, and gadgets are aligned, and thus lists the objects 102. Examples of the object group 101 are the short cut menu for calling various functions and programs, a launcher, and the task bar.

As described above, the object group 101 lists the plurality of objects 102, and the plurality of objects 102 are continuously aligned therein. According to the present exemplary embodiment, the object group 101 includes a starting portion 105, a first expanded portion 106 which expands from the starting portion 105 in one predetermined direction, and a second expanded portion 107 which expands from the starting portion 105 in a direction different from that of the first expanded portion 106. According to the present exemplary embodiment, the first expanded portion 106 expands from the starting portion 105 in a vertical direction (i.e., an upward or a downward direction), and the second expanded portion 107 expands from the starting portion 105 in a horizontal direction (i.e., a left or a right direction). According to the present exemplary embodiment, expansion directions of the first expanded portion 106 and the second expanded portion 107 are thus perpendicular to each other.

In the example illustrated in FIG. 2, the first expanded portion 106 expands upwards from the starting portion 105, and the second expanded portion 107 expands in the left direction from the starting portion 105. The object group 101 is thus displayed as an inverted L-shape. In other words, the plurality of objects is arranged so that the object group 101 becomes inverted L-shaped. According to the present exemplary embodiment, the starting portion 105 becomes a base point when the object group 101 is moved. The object group 101 becomes movable only in the case where the user has dragged the starting portion 105 in the object group 101. According to the present exemplary embodiment, since the object 102 is not arranged in the starting portion 105, the starting portion 105 is blacked out.

If the user drags the starting portion 105 using a pointing device as the input device 207, the user makes a drag operation by placing a pointer of the pointing device on the starting portion 105. If the user uses the touch panel as the input device 207, the user touches and drags the starting portion 105.

Further, according to the present exemplary embodiment, the starting portion 105 is a reference point which becomes the reference when expanding in a predetermined direction objects 102 that are included in the object group 101. An object in the object group 101 arranged at a predetermined position, i.e., an object 102, may be set as the starting portion 105. Further, a box of a predetermined size, such as a box of the same shape as the object, arranged between predetermined objects may be set as the starting portion 105. According to the present exemplary embodiment, the starting portion 105 which is a box of the same size and shape as the objects is set at a pre-designated position in the object group 101.

All objects included in the object group 101 may be displayed, or a portion of the objects included in the object group 101, such as only the designated objects, may be displayed as the object group 101. If only a portion of the objects included in the object group 101 is to be displayed, the list of objects included in the object group may be displayed by the user dragging the starting portion 105. Further, the object group 101 may be configured such that the number of objects to be displayed among the objects included in the object group 101 can be increased or decreased. In such a case, if the number of objects to be displayed is increased or decreased, the number of objects in at least one of the expanded portions is increased or decreased.

The object group 101 can be displayed in a predetermined area on the display screen 103. According to the present exemplary embodiment, the object group 101 can be displayed in a preset displayable area 104, and is movable to an arbitrary position within the displayable area 104. Further, according to the present exemplary embodiment, the user can move the entire object group 101 by selecting and moving the starting portion 105.

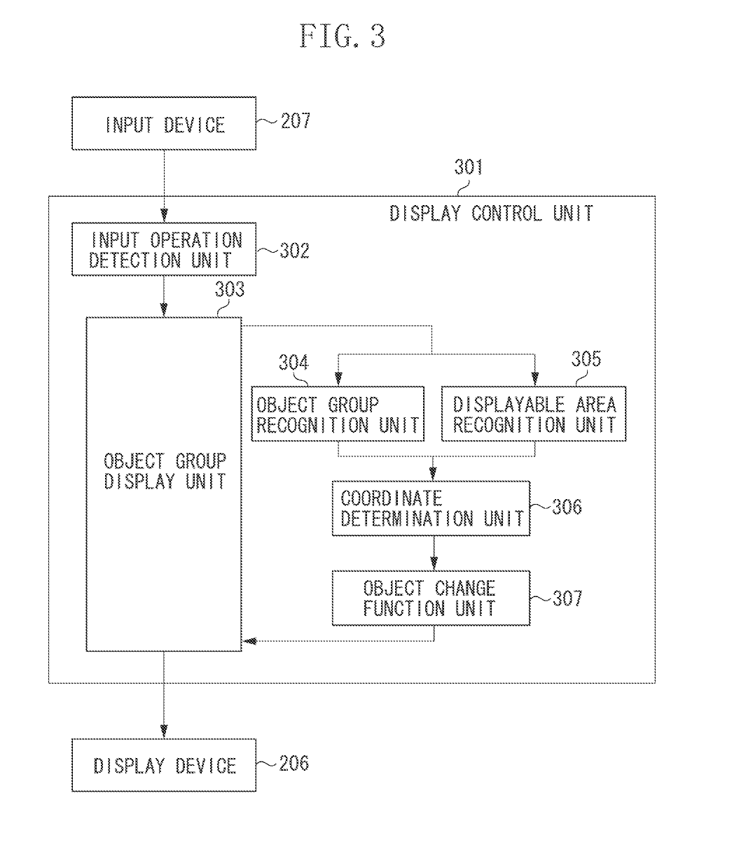

The program which runs on the display control apparatus 201 will be described below with reference to FIG. 3. FIG. 3 is a block diagram illustrating the configuration of the application software which controls the object group 101 displayed on the display screen 103 of the display device 206 in the display control apparatus 201.

Referring to FIG. 3, the input device 207 receives input for moving and changing the display of the object group 101 displayed on the display device 206. More specifically, the user inputs via the input device 207 operation information with respect to the object group 101. The input device 207 then transfers to a display control unit 301 the information input by the user.

The display control unit 301 receives the information on the input operation from the input device 207, and transmits the information to the display device 206. More specifically, an input operation detection unit 302 detects the input operation input from the input device 207, and informs an object group display unit 303 on the input operation information.

The object group display unit 303 displays on the display device 206, a state in which the user is continuing the input operation for moving the object group, and a state in which the user has ended the input operation. The object group display unit 303 displays the two states in a distinguishable manner. According to the present exemplary embodiment, if the user is continuing the input operation for moving the object group, the object group 101 including the objects 102 is displayed in a translucent state to indicate that the user is continuing the input operation (i.e., the user is dragging the object group 101). On the other hand, if the user has ended the input operation, the object group 101 including the objects 102 is displayed cancelling the translucent state to indicate that user is not performing the input operation (i.e., the user has ended dragging or is not dragging the object group 101).

An object group recognition unit 304 receives, if an instruction to move the object group 101 is input, coordinate information of the object group 101 from the object group display unit 303. As a result, the object group recognition unit 304 recognizes the coordinates of the starting portion 105, and the coordinates, sizes, and the expansion directions of the first expanded portion 106 and the second expanded portion 107.

A displayable area recognition unit 305 recognizes from the object group display unit 303, the displayable area 104 of the object group 101 as the coordinates. One or more object groups 101, i.e., a plurality of object groups 101, can be displayed on the display screen. According to the present exemplary embodiment, the object group 101 to be recognized will be referred to as a target object group.

A coordinate determination unit 306 determines, based on the coordinates of the object group 101 in the case where the object group 101 is moved according to the information input from the input device 207, whether it is necessary to change the shape of the object group 101. The shape of the object group 101 is changed by correcting the arrangement of each object (i.e., the expanded portion) in the object group 101. More specifically, the coordinate determination unit 306 acquires from the object group recognition unit 304 the coordinate information of the target object group 101. Further, the coordinate determination unit 306 acquires from the displayable area recognition unit 305 the coordinate information of the displayable area 104. The coordinate determination unit 306 then compares the acquired information, and determines whether the entire target object group 101 exists within the displayable area 104. If the object group 101 exists outside the displayable area 104, the coordinate determination unit 306 determines to perform display correction. The above-described coordinates are the coordinates in the display screen 103.

An object change function unit 307 receives from the coordinate determination unit 306, coordinate determination information of the target object group 101. If the object change function unit 307 receives the determination result to perform display correction, the object change function unit 307 generates information for changing the objects. More specifically, the object change function unit 307 changes the display area of the object group 101 and corrects the arrangement of a portion of the objects 102 included in the object group 101. The object change function unit 307 thus generates display information for changing the shape of the object group. The object change function unit 307 generates the display information on the display area of the target object group 101 after the target object group 101 has been corrected, a display order of the objects 102 in the target object group 101 after the arrangement of the objects 102 has been corrected, and a display position of the target object group. The object change function unit 307 then transmits the generated display information to the object group display unit 303.

The object group display unit 303 re-displays on the display device 206 the target object group 101 based on the display information received from the object change function unit 307. The object change function unit 307 may generate and transmit a plurality of display information. If the display device 206 receives a plurality of display information, the display device 206 may re-display the plurality of display information at the same time, or re-display in stages the display information a plurality of times at constant intervals.

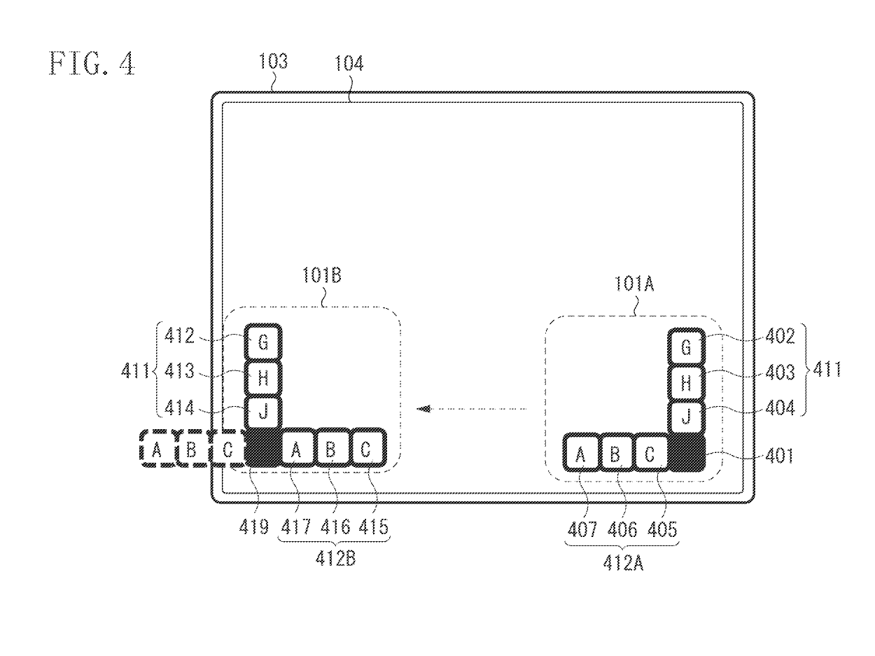

The method for displaying the object group 101 according to the present exemplary embodiment will be described below with reference to FIG. 4. FIG. 4 illustrates an example of the method for displaying the object group 101 according to the present exemplary embodiment.

Referring to FIG. 4, the displayable area 104 is an area indicating a display boundary of the object group 101. In other words, the object group 101 can be displayed only within the displayable area 104. The displayable area 104 is preset in an arbitrary position in the display screen 103, and the entire display area of the display screen 103 may be set as the displayable area 104.

According to the present exemplary embodiment, an object group 101A before being moved is arranged at a lower right portion of the displayable area 104 illustrated in FIG. 4. The object group 101A is a collection of objects, and each object is listed therein. The object group 101A includes a starting portion 401, a first expanded portion 411 including three objects 402, 403, and 404, and a second expanded portion 412A including three objects 405, 406, and 407. Each object included in the object group 101A has an application launcher function for instructing activation of an application assigned thereto. In the object group 101A, the first expanded portion 411 expands upwards from the starting portion 401, and the second expanded portion 412A expands in the left direction from the starting portion 401, so that the object group 101A is inverted L-shaped.

If the user moves the object group 101A to the lower left portion of the displayable area 104, the second expanded portion 412A is placed outside the displayable area 104. In such a case, the object change function unit 307 performs display correction of the object group 101A, so that the object group 101A becomes an object group 101B having an arrangement and a shape as illustrated in FIG. 4. More specifically, the object change function unit 307 changes the expansion direction of the second expanded portion 412A in the object group 101A to an opposite direction with reference to the starting portion 401. In other words, the second expanded portion 412A in the object group 101A is expanded in the left direction from the starting portion 401 to be inverted L-shaped, whereas a second expanded portion 412B in the object group 101B is expanded in the right direction from the starting portion 401. Further, the arrangement of the objects in the second expanded portion 412B in the object group 101B is the same as an arrangement order of the objects 405, 406, and 407 from the starting portion 401 in the second expanded portion 412A in the object group 101A. The objects in the second expanded portion 412B are thus arranged in the order from the starting portion 401 as A, B, and C.

In the above-described example, an animated motion when correcting the display of the object group 101A is not particularly limited. For example, the display correction of the object group 101A is performed by sliding the second expanded portion 412A in the right direction. The display correction may be performed by inverting the second expanded portion 412A, or the display may be switched to the display after correction without the animated motion.

FIG. 4 illustrates the case where all objects included in the second expanded portion 412A of the object group 101A are placed outside the displayable area 104. The objects are similarly changed when one or two objects included in the second expanded portion are placed outside the displayable area 104.

The object group 101B after being moved includes the starting portion 401, the first expanded portion 411 including the three objects 402, 403, and 404, and the second expanded portion 412B including the three objects 405, 406, and 407, similarly to the object 101A. In other words, the number of objects in the object group 101B which are to be displayed is the same as that in the object group 101A, i.e., the configuration including the originating portion, the first expanded portion, and the second expanded portion is maintained. Further, each object included in the object group 101B after being moved includes the same application launcher function as each object included in the object group 101A before being moved.

As described above, if the user moves the object group 101, the object group 101B in which the display correction has been performed is displayed. Further, the object group 101B in which the second expanded portion 412B expands in the right direction from the starting portion 401 may be displayed after temporarily displaying the state before performing the display correction. Furthermore, the object group before performing the display correction may be displayed while the user is moving (i.e., dragging) the object group 101. In such a case, only the objects existing in the display area 104 among the objects in the second expanded portion may be temporarily displayed. Moreover, if there is a display area outside the displayable area 104 of the display screen 103, the second expanded portion in the translucent state may be temporarily displayed in the display area.

As described above, according to the present exemplary embodiment, if one of the expanded portions of the object group 101 cannot be displayed within the displayable area 104, the expansion direction of the expanded portion that cannot be displayed is changed to the opposite direction around the starting portion 401. As a result, all of the objects displayed on the expanded portion are displayed within the displayable area 104.

FIG. 4 illustrates an example in which the object group 101A is moved in the horizontal direction (to the left side) of the displayable area 104. The process is similarly performed in the case where the object group 101A is moved in other directions. In other words, if one or more objects included in the expanded portion of the object group 101A is placed outside the displayable area 104 by the user moving the object group 101A, the shape of the object group 101A is changed. As a result, all of the objects displayed on the expanded portion are displayed within the displayable area 104. For example, if the object group 101A illustrated in FIG. 4 is moved in the upward direction within the displayable area 104, not all of the objects included in the first expanded portion 411 can be displayed within the displayable area 104. The second expanded portion 411 is thus inverted with the starting portion 401 as an origin, and is expanded in a downward direction from the starting portion 401.

As described above, control is performed to display the object group 101 in the display screen 103 so that the working area of the user is secured, and all of the objects included in the object group 101B are displayed. The visibility and the operability are thus improved.

Further, according to the present exemplary embodiment, the object group 101 includes the starting portion 401, the first expanded portion 411 which expands in the vertical direction of the display screen 103, and the second expanded portion which expands in the horizontal direction of the display screen 103. As a result, if the object group 101 is arranged at a corner of the display screen 103, the first expanded portion 411 and the second expanded portion can be respectively arranged along a display frame of the screen. By displaying the object group 101 in such a state, a sufficient space area can be set within the displayable area 104, and the screen for other application software can be displayed on the space area. The working area of the user can thus be sufficiently secured, and the operability is improved.

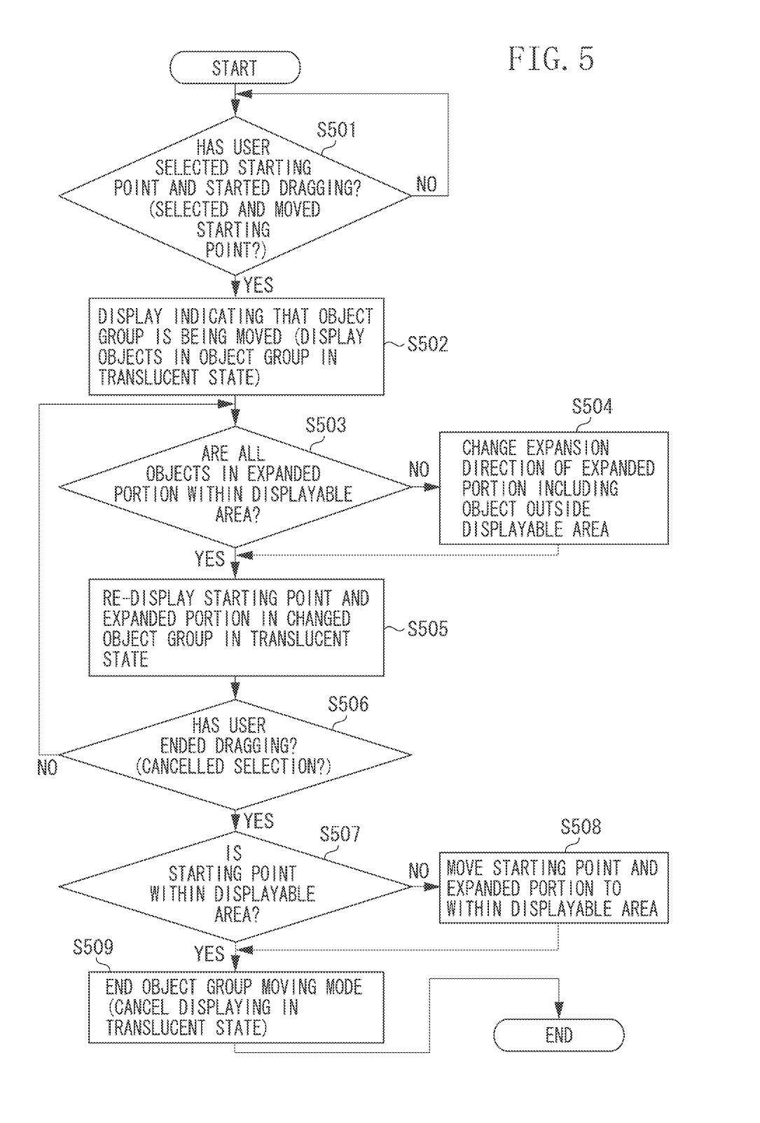

FIG. 5 is a flowchart illustrating the display control process performed when the user moves the object group 101 within the displayable area 104. The flowchart illustrated in FIG. 5 indicates a flow of the process which is performed by the CPU 202 executing the program of the application software illustrated in FIG. 3.

In step S501, the CPU 202 determines whether the instruction to start moving the object group 101 has been issued. According to the present exemplary embodiment, the CPU 202 determines whether the user has selected and dragged (moved) using the input device 207 the starting portion 401 in the object group 101A before being moved. If the CPU 202 determines that the user has selected and dragged the starting portion 401 (YES in step S501), the process proceeds to step S502.

In step S502, the CPU 202 performs display so that the user can recognize the object group 101 is being moved. According to the present exemplary embodiment, the object group is displayed as being in the middle of moving by making the objects included in the object group 101 translucent. For example, when the object group is moved from the position of the object group 101A before being moved, to the predetermined position of the object group 101B after being moved, each expanded portion is re-displayed (redrawn) in the translucent state while the arrangement of the objects expanded from the starting portion is maintained as in the initial state.

In step S503, the CPU 202 determines whether all objects included in each expanded portion in the object group 101 exist within the displayable area 104. According to the present exemplary embodiment, the coordinate determination unit 306 determines whether the coordinates of the objects included in the object group 101 are within the displayable area 104. If the coordinates of the objects which has been moved, included in the expanded portion of the object group 101A before being moved, are outside the displayable area 104 (NO in step S503), the process proceeds to step S504. According to the present exemplary embodiment, when an end of the expanded portion which is at the opposite side from the starting portion reaches the display boundary of the displayable area 104, the process proceeds to step S504. On the other hand, if the coordinates of the objects which has been moved, included in the expanded portion of the object group 101A before being moved, are within the displayable area 104 (YES in step S503), the process proceeds to step S505.

In step S504, the CPU 202 changes, if one or more objects included in the expanded portion exist outside the displayable area 104, the expansion direction of the expanded portion including the objects, and thus changes the shape of the object group. As a result, the CPU 202 displays within the displayable area 104 all objects included in the object group.

In step S505, the CPU 202 re-displays in the translucent state, the object group after changing the shape. In the example illustrated in FIG. 4, the object group 101B including the starting portion 401, the first expanded portion 411, and the second expanded portion 412B is re-displayed in the translucent state. In other words, when the object group 101 is re-displayed after being moved, the expansion direction of the second expanded portion 412A expanded in the left direction from the starting portion 401 is changed to the right direction from the starting portion 401. The object group 101 including the plurality of objects is thus displayed within the displayable area 104.

In step S506, the CPU 202 determines whether the user has completed moving the object group by dragging. If the CPU 202 determines that the user has not completed moving the object group by dragging (NO in step S506), the process returns to step S503. If the CPU 202 determines that the user has completed moving the object group by dragging (YES in step S506), the process proceeds to step S507.

In step S507, the CPU 202 determines whether the starting portion 401 exists within the displayable area 104. When the starting portion 401 exists outside the displayable area 104, at least a portion of the starting portion 401 has moved outside the displayable area 104. If the CPU 202 determines that the starting portion 401 exists within the displayable area 104 (YES in step S507), the process proceeds to step S509. If the CPU 202 determines that the starting portion 401 exists outside the displayable area 104 (NO in step S507), the process proceeds to step S508

In step S508, the CPU 202 moves the entire object group 101A which is being moved, to the inside of the displayable area 104. In other words, the CPU 202 performs display correction of the object group 101A after being moved so that the starting portion 401 and the expanded portions included in the object group 101A are moved to the inside of the displayable area 104.

If the CPU 202 determines in step S507 that the starting portion 401 is within the displayable area 104, the display correction of the object group 101A after being moved is not performed. In step S509, the CPU 202 cancels the translucent state of the object group 101A and ends moving the object group 101.

In the display control process illustrated in FIG. 5, the object group is caused to be in the translucent state while being moved, so that the user can identify whether the object group is being moved. However, the display method is not limited thereto, as long as it can be identified whether the object group is being moved.

According to the present exemplary embodiment, in step S503, the process proceeds to step S504 when the object group 101 moves and the end of the expanded portion in the object group (at the opposite side of the starting portion) reaches the display boundary of the displayable area 104. However, it is not limited thereto. For example, when the objects included in the expanded portion reach the outside of the displayable area 104 while the object group 101 is being moved, the expanded portion may be displayed to be temporarily arranged outside the displayable area 104. The shape of the object group may then be changed after the user has ended moving the object group 101.

According to the present exemplary embodiment, display control is performed so that the object group including the plurality of objects is configured of the starting portion 401, the first expanded portion 411 which expands in the vertical direction of the display screen 103, and the second expanded portion which expands in the horizontal direction of the display screen. Further, if the objects included in the expanded portion of the object group cannot be displayed within the displayable area 104 when the user moves the object group, control is performed to invert the expanded portion around the starting portion 401. The expanded portion is thus displayed within the displayable area 104. As described above, the object group including the plurality of objects is listed without performing reduced display or non-display. The object group or the objects included in the object group are thus not hidden, or become divided and difficult for viewing as in a case of the conventional technique. As a result, the visibility and the operability of the objects are improved, and the working area in the display screen 103 is sufficiently secured. In particular, if the object group 101 is arranged at the corner of the displayable area 104 in the display screen 103, and each expanded portion is arranged along the frame of the displayable area 104, the working area on the display screen can be sufficiently secured.

Further, according to the present exemplary embodiment, the object group is displayed so that the arrangement order of the objects in each expanded portion included in the object group is the same as the order before changing the shape. In other words, the object group is displayed without changing the arrangement order of the objects in each expanded portion included therein. As a result, user operability is improved. If the objects are arranged with a special intention, it is particularly effective.

Furthermore, according to the present exemplary embodiment, the first expanded portion is expanded in the vertical direction of the display screen 103, and the second expanded portion is expanded in the horizontal direction even if the expansion direction of each expanded portion is changed. As a result, if the objects included in the object group 101 are intentionally divided into each expanded portions and arranged, for example, divided according to each category, visibility and operability are further improved. Moreover, if the object group 101 is arranged at the corner of the display screen 103, the first expanded portion 411 and the second expanded portion can be respectively arranged along the display frame of the screen, so that a sufficient space area can be provided within the displayable area 104. As a result, the working area of the user can be sufficiently secured, and the operability is improved.

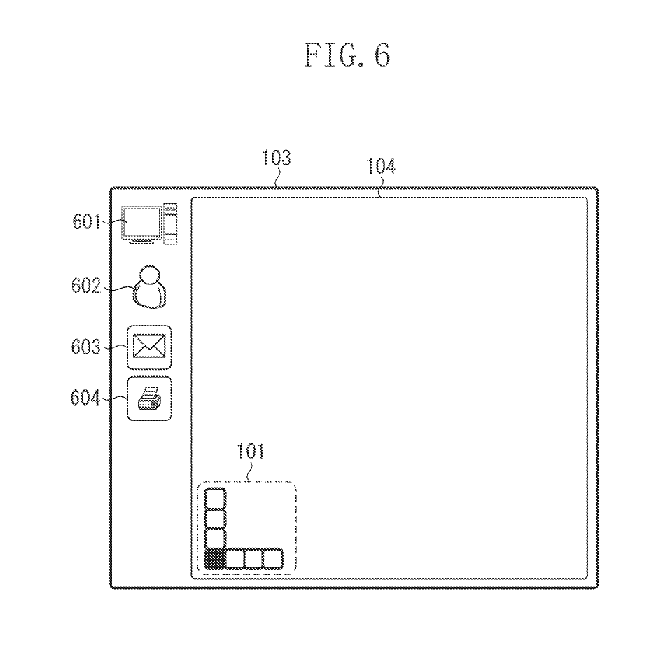

FIG. 6 illustrates a method for controlling display of the object group 101 according to the second exemplary embodiment. According to the present exemplary embodiment, only the display control method for displaying on the display screen 103 and displaying the object group on the display screen 103 are different from that of the first exemplary embodiment. More specifically, the configuration of the display control apparatus 201 and the software running on the display control apparatus 201 according to the present exemplary embodiment are the same as in the first exemplary embodiment, so that overlapping description will be omitted.

Referring to FIG. 6, according to the present exemplary embodiment, the display screen 103 includes a plurality of objects 601, 602, 603, and 604, and the displayable area 104 disposed in a range that does not overlap with the plurality of objects 601, 602, 603, and 604. According to the present exemplary embodiment, control is performed to display the object group 101 within the displayable area 104, i.e., the object group 101 does not overlap with each of the objects 601, 602, 603, and 604 arranged outside the displayable area 104.

Further, according to the present exemplary embodiment, the display control apparatus 201 includes a function for setting the displayable area 104. The setting function sets the area other than the area in which the objects 601, 602, 603, and 604 not included in the object group 101 are displayed, as the displayable area 104. The setting function can change (provided) the range of the displayable area as appropriate according to addition or deletion of an object not included in the object group 101. In such a case, the displayable area may be automatically changed along with addition or deletion of the object.

The objects not belonging to the object group 101 within the displayable area 104 are not particularly limited. For example, the object 601 may be a computer folder which refers to a folder file in the computer, the object 602 a user folder which refers to a folder of the user, the object 603 an e-mail icon for activating e-mail software, and the object 604 a printer icon for causing a predetermined printer to print.

Furthermore, according to the present exemplary embodiment, display control is performed similarly to the first exemplary embodiment so that the object group including the plurality of objects is configured as follows. The object group is configured of the starting portion, the first expanded portion expanding from the starting portion in the vertical direction of the display screen 103, and the second expanded portion expanding from the starting portion in the horizontal direction of the display screen 103. If the objects included in the expanded portion of the object group cannot be displayed within the displayable area 104 when the user moves the object group, the expansion direction of the expanded portion is changed and reversed around the starting portion 401. The expanded portion is thus displayed within the displayable area 104. As a result, the visibility and the operability of the objects are improved, and the working area on the display screen 103 is sufficiently secured, similarly to the first exemplary embodiment. Further, in such a case, the operations of the objects 601, 602, 603, and 604 are not interrupted.

According to the present exemplary embodiment, the order of arranging the objects in the expanded portion configuring the object group starting portion, is the same between before and after changing the expansion direction, similarly to the first exemplary embodiment. In other words, the object group is displayed without changing the arrangement order starting portion of the objects in each expanded portion configuring the object group. As a result, the user operability is improved. It is particularly effective when the objects are aligned in an intentional order.

Further, according to the present exemplary embodiment, the relation of the first expanded portion expanded in the vertical direction and the second expanded portion in the horizontal direction of the display screen 103 is maintained even when the expansion directions of each expanded portion are changed, similar to the first exemplary embodiment. As a result, if the objects included in the object group 101 are arranged by intentionally dividing into each expanded portion, e.g., according to each category, the visibility and the operability are further improved.

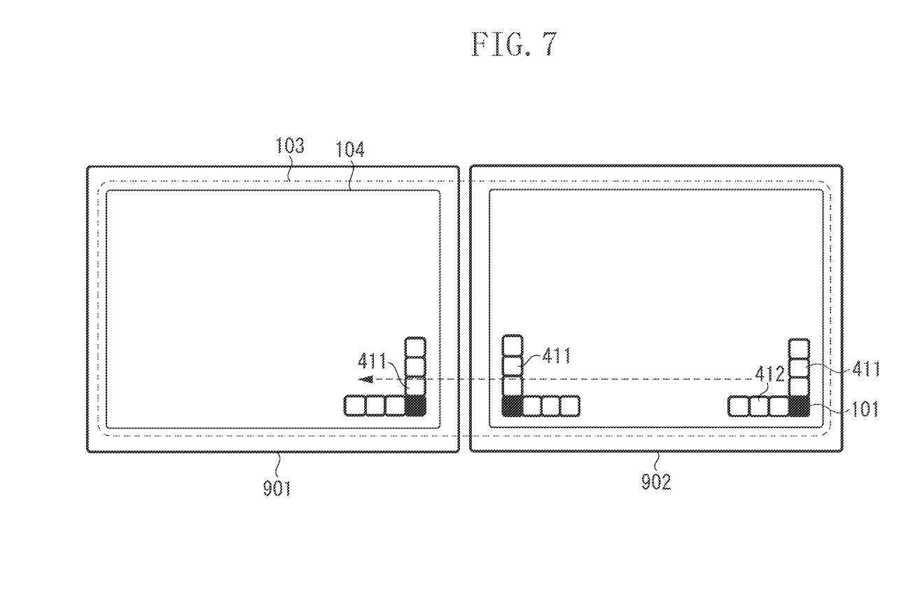

FIG. 7 illustrates a method for controlling display of the object group 101 according to the third exemplary embodiment of the present invention. The display control method for displaying the object group on the display screen 103 according to the present exemplary embodiment is different from that of the first exemplary embodiment. More specifically, the configuration of the display control apparatus 201 and the software running on the display control apparatus 201 according to the present exemplary embodiment are the same as in the first exemplary embodiment, so that the overlapping description will be omitted.

According to the present exemplary embodiment, the display screen 103 is configured of a plurality of displays 901 and 902, and belongs to each of the displays 901 and 902. Further, the displayable area 104 is provided in each of the displays 901 and 902. The displayable area 104 is preset by the OS.

Referring to FIG. 7, if the object group 101 displayed in the lower right portion of the display 902 is moved in the horizontal direction (i.e., to the left illustrated in FIG. 7), the shape of the object group 101 changes according to the position within the displayable area 104 of the display screen 103.

More specifically, when the user moves the object group 101 to the lower left portion of the display 902, the shape thereof is formed by changing the arrangement of the plurality of objects, similarly to the first exemplary embodiment. The expansion direction of the second expanded portion 412 which has been expanded in the left direction from the blacked-out starting portion 401 is thus changed to the reverse direction with respect to (reference to) the starting portion 401. As a result, the second expanded portion 412 is expanded in the right direction from the starting portion 401. By correcting the arrangement of the expanded portion of the object group 101 as described above, the shape of the object group 101 is changed from the inverted L-shape to an L-shape.

If the user then further moves the object group 101 in the horizontal direction (i.e., in the left direction) to the lower right portion of the display 901, the second expanded portion 412 expanded in the right direction from the starting portion 401 cannot be displayed within the displayable area 104 of the display 901. The second expanded portion 412 in the object group 101 expanded in the right direction is thus again reversed with respect to (reference to) the starting portion 401 to be expanded in the left direction from the starting portion 401. As a result, the shape of the object group 101 is re-changed from the L-shape to the inverted L-shape.

Further, if the user further moves the object group in the horizontal direction (i.e., in the left direction, not illustrated) to the lower left portion of the display 901, the second expanded portion 412 expanded in the left direction from the starting portion 401 cannot be displayed within the displayable area 104 of the display 901. As a result, the second expanded portion 412 in the object group 101 is again reversed with respect to (reference to) the starting portion 401 to be expanded in the right direction from the starting portion 401. As a result, the shape of the object group 101 is changed from the inverted L-shape to the L-shape.

According to the present exemplary embodiment, if there is a plurality of displayable areas 104 as in the case of using a plurality of displays, the objects included in the object group 101 are not arranged in the boundary of the displayable area 104. In other words, control is performed to change the shape of the object group at the boundary area of the display screen in each display. More specifically, the expansion direction of the expanded portion including the objects that protrude between the display screens of the display is changed with reference to the starting portion. The shape of the object group 101 is thus changed to be displayable within the displayable area 104. For cases other than the above-described case, control is performed similarly to the first exemplary embodiment so that the object group including the plurality of objects is configured of the starting portion 401, the first expanded portion expanding from the starting portion in the vertical direction of the display screen 103, and the second expanded portion expanding from the starting portion 401 in the horizontal direction of the display screen 103. Further, if the objects included in the expanded portion 401 of the object group cannot be displayed within the displayable area 104 when the user moves the object group 101, control is performed as follows. The expansion direction of the expanded portion is changed around the starting portion 401, so that the objects are displayed within the displayable area 104.

As a result, the visibility and the operability of the objects are improved even when using the plurality of displays, and the working area on the display screen 103 can be sufficiently secured.

According to the present exemplary embodiment, the order of arranging the objects in the expanded portion configuring the object group, is the same between before and after changing the expansion direction, similarly to the first exemplary embodiment. In other words, the object group is displayed without changing the arrangement order of the objects in each expanded portion configuring the object group. As a result, the user operability is improved. It is particularly effective when the objects are aligned in an intentional order.

Further, according to the present exemplary embodiment, the relation of the first expanded portion expanded in the vertical direction of the display screen 103 and the second expanded portion in the horizontal direction is maintained even when the expansion directions of each expanded portion are changed similar to the first exemplary embodiment. As a result, if the objects included in the object group 101 are arranged by intentionally dividing into each expanded portion, e.g., according to each category, the visibility and the operability are further improved.

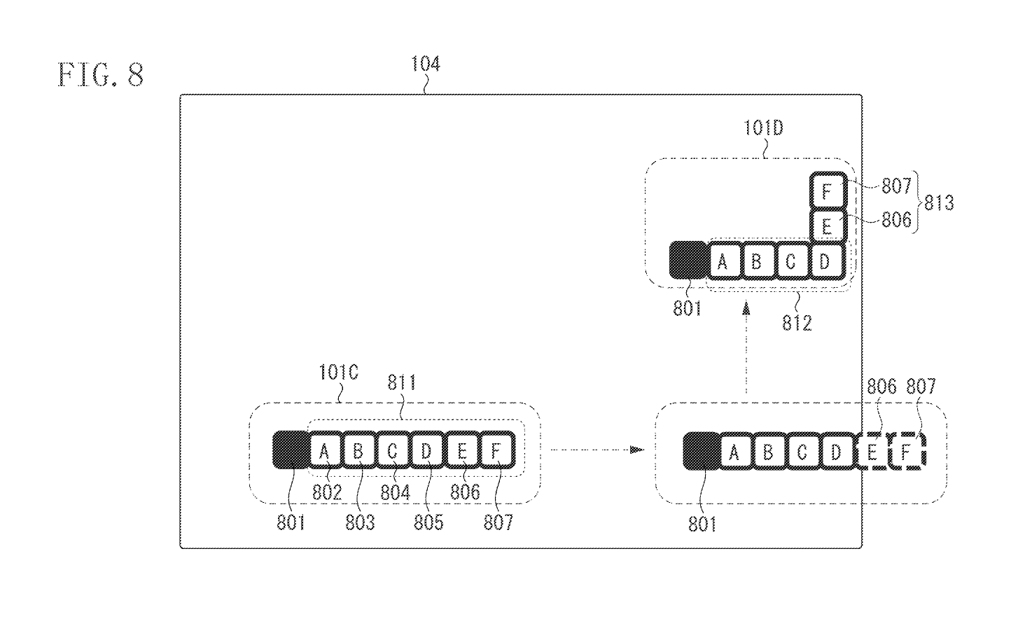

FIG. 8 illustrates a method for controlling display of the object group 101 according to the fourth exemplary embodiment. Only the display control method for displaying the object group on the display screen 103 according to the present exemplary embodiment is different from the first exemplary embodiment. More specifically, the configuration of the display control apparatus 201 and the software running on the display control apparatus 201 according to the present exemplary embodiment are the same as in the first exemplary embodiment, so that overlapping description will be omitted.

According to the present exemplary embodiment, the display screen 103 includes the displayable area 104 capable of displaying an object group 101C. The object group 101C includes a starting portion 801 and an expanded portion 811 expanded from the starting portion 801. The expanded portion 811 includes objects 802, 803, 804, 805, 806, and 807. The user can move the object group 101C within the displayable area 104 by selecting and moving the starting portion 801.

Further, according to the present exemplary embodiment, the starting portion 801 becomes a base point when the user moves the object group 101C. However, the starting portion 801 does not become the base point when changing the expansion direction of the expanded portion 811 unlike the first, second, and third exemplary embodiments. In other words, according to the present exemplary embodiment, the starting portion 801 is the base point in the case where the object group 101C is moved, unlike the first, second, and third exemplary embodiments.

Referring to FIG. 8, if the user moves in the horizontal direction (i.e., in the right direction) the object group 101C positioned in the lower left portion of the displayable area 104 to the lower right portion of the displayable area 104, the following occurs. The objects 806 and 807 do not fit within the displayable area 104 and thus are placed outside the displayable area 104. To solve such a problem, the shape of the object 101C is changed so that the objects 806 and 807 are displayed within the displayable area 104. According to the present exemplary embodiment, control is performed to change the shape of the expanded portion 811 in the object group 101C so that all objects included in the expanded portion of the object group 101C become displayable within the displayable area 104. More specifically, the positions of the objects which are placed outside the displayable area 104 are moved, among the objects included in the expanded portion 811 in the object group 101C, and the expansion direction of the expanded portion 811 is changed. The shape of the object group 101C is thus changed. In other words, the expanded portion of the object group 101C is bent to be arranged along the frame of the displayable area 104. In the example illustrated in FIG. 8, the objects 806 and 807 included in the object group 101C are expanded in the direction along the frame of the displayable area 104. As a result, an object group 101D which is configured of the starting portion 801, a first expanded portion 812 expanded in the horizontal direction (i.e., in the right direction) with respect to the starting portion 801, and a second expanded portion 813 expanded in the vertical direction (i.e., upward direction) with respect to the starting portion 801 becomes inverted L-shaped. In such a case, the arrangement order (i.e., the arrangement order) of the expansion portion 811 starting portion is not changed and thus maintained.

As described above, the arrangement of the objects 806 and 807 which protrude outside the displayable area 104, among the objects included in the object group 101C in the middle of moving, is changed. The shape of the object group 101C is thus changed to a shape which fits within the displayable area 104, and the object group 101C is re-displayed.

When the user moves the object group 101C within the displayable area 104, control is constantly performed to bend the expanded portion 811, i.e., the expansion direction is constantly controlled.

According to the present exemplary embodiment, if the objects included in the object group 101C again protrude outside the displayable area 104 after the expansion direction of the expanded portion 811 is controlled to change, the expanded portion 811 may be bent a plurality of times.

Further, the object group 101C is moved to the area within the displayable area 104 illustrated in FIG. 8 in which there is no overlap with the objects not included in the object group 101C, similarly to the third exemplary embodiment. In other words, the displayable area 104C is provided in the area which does not overlap with the objects not belonging to the object group 101C.

As described above, the expanded portion 811 in the objet group 101C is bent without being inverted, so that all objects included in the expanded portion 811 are displayed within the displayable area 104.

According to the present exemplary embodiment, if the objects included in the expanded portion in the object group including the plurality of objects cannot be displayed within the displayable area 104 when the user moves the object group, the expanded portion of the object group 101C is bent. All objects included in the expanded portion 811 are thus displayed. As a result, the object group and the objects included in the object group do not become hidden or divided and difficult for viewing as in the conventional technique. The working area on the display screen can be secured, and the visibility and the operability can be improved.

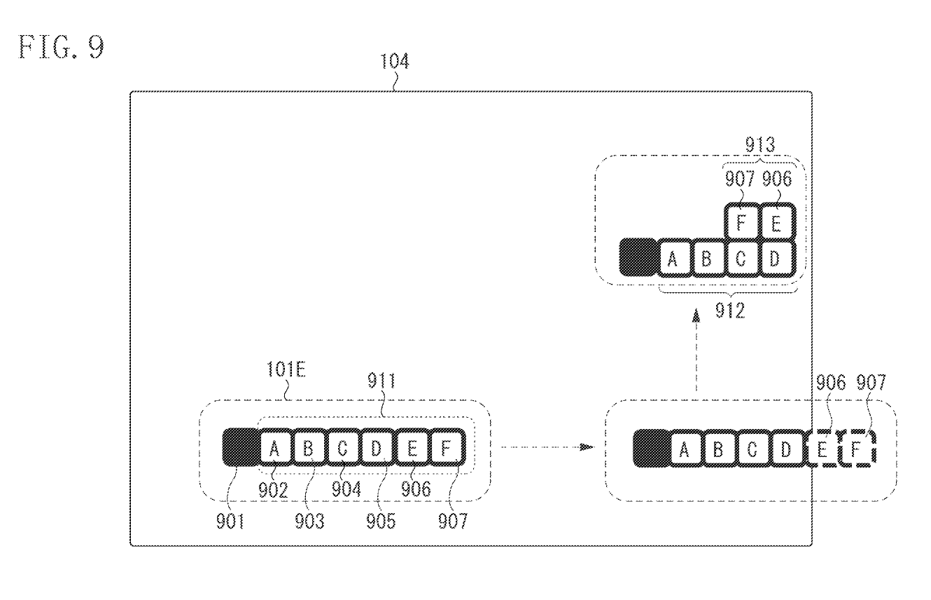

FIG. 9 illustrates a method for controlling display of the object group 101 according to the fifth exemplary embodiment of the present invention. Only, the display control method for displaying the object group on the display screen 103 according to the present exemplary embodiment is different from the first exemplary embodiment. More specifically, the configuration of the display control apparatus 201 and the software running on the display control apparatus 201 according to the present exemplary embodiment are the same as in the first exemplary embodiment, so that the overlapping description will be omitted.

According to the present exemplary embodiment, the display screen 103 includes the displayable area 104 capable of displaying an object group 101E. The object group 101E includes a starting portion 901 and an expanded portion 911 expanded from the starting portion 901. The expanded portion 911 includes objects 902, 903, 904, 905, 906, and 907. The user can move the object group 101E within the displayable area 104 by selecting and moving the starting portion 901.

Further, according to the present exemplary embodiment, the starting portion 901 becomes the base point when the user moves the object group 101E. However, the starting portion 901 does not become the base point when changing the expansion direction of the expanded portion 911, unlike the first, second, and third exemplary embodiments. In other words, according to the present exemplary embodiment, the starting portion 901 is the base point in the case where the user moves the object group 101E, unlike the first, second, and third exemplary embodiments.

Referring to FIG. 9, if the user moves the object group 101E positioned in the lower left portion of the displayable area 104 in the horizontal direction (i.e., in the right direction), to the lower right portion of the displayable area 104, the following occurs. The objects 906 and 907 do not fit within the displayable area 104 and are thus placed outside the displayable area 104. To solve such a problem, the shape of the object 101E is changed so that the objects 906 and 907 are displayed within the displayable area 104. According to the present exemplary embodiment, control is performed to change the shape of the expanded portion 911 in the object group 101E so that all objects included in the expanded portion of the object group 101E become displayable within the displayable area 104. More specifically, the positions of the objects which are placed outside the displayable area 104 are moved, among the objects included in the expanded portion 911 in the object group 101E, and the expansion direction of the expanded portion 911 is changed. The shape of the object group 101E is thus changed. In other words, an expanded portion of the object group 101E is arranged above a first expanded portion 912 expanded in the horizontal direction (i.e., in the right direction) from the starting portion 901. A new expanded portion 913 is thus expanded in the horizontal direction (i.e., in the left direction) from above the object 905 in the object group 101E. The objects in the object group 101E which do not fit within the displayable area 104 are thus folded back and inverted to be adjacent to other objects, so that the objects are expanded and displayed. As a result, the object group 101E is configured of the starting portion 901, the first expanded portion 912, and the second expanded portion 913. The first expanded portion 912 is expanded in the horizontal direction (i.e., in the right direction) from the starting portion 901. The second expanded portion 913 is continuously arranged from the object 905 positioned at the end of the first expanded portion 912 and arranged to be adjacent to the first expanded portion 912. In this case, the arrangement order of the expanded portion 911 is not changed and maintained.

According to the present exemplary embodiment, the arrangement of the objects 906 and 907 which are placed outside the displayable area 104, is changed, among the objects included in the object group 101E in the middle of moving. The shape of the object group 101E is thus changed to have the shape which fits within the displayable area 104, and the object group 101E is re-displayed. In other words, as illustrated in FIG. 9, the object 906 is arranged above the object 905 included in the object group 101E, and the object 907 is arranged subsequent to the object 906 to re-display the object group 101E.

When the object group 101E is moved within the displayable area 104, control is constantly performed to bend the expanded portion of the object group 101E, i.e., the expansion direction is constantly controlled.

According to the present exemplary embodiment, if the objects in the expanded portion in the object group which includes the plurality of objects cannot be displayed within the displayable area 104 when the user moves the object group, the expanded portion of the object group 101E is bent. All objects included in the expanded portion are thus displayed. As a result, the object group and the objects included in the object group do not become hidden or divided and difficult for viewing as in the conventional technique. The working area on the display screen can be secured, and the visibility and the operability can be improved.

The basic configuration of the present invention is not limited to the above-described exemplary embodiments.

According to the first, second, third, fourth, and fifth exemplary embodiments, the object groups include seven objects. However, it is not limited thereto, and similar effects can be achieved with two or more objects. Further, according to the first, second, and third exemplary embodiments, the object groups include three expanded portions. However, the number of expanded portions may be different.

According to the first, second, third, fourth, and fifth exemplary embodiments, the position of the starting portion in the object group 101 is preset. However, the user may arbitrarily select the position of the starting portion in the object group from the objects.

According to the first, second, third, fourth, and fifth exemplary embodiments, the object is not arranged in the starting portion. However, it is not limited thereto. The object may be arranged and displayed at the starting portion, or the starting portion may include a link for displaying a list of a plurality of objects not displayed on the display screen. If the starting portion includes the link for displaying the list, the number of objects in the expanded portion may be decreased by arranging the object in the starting portion, or may be increased by extracting the objects from the starting portion.

According to the second exemplary embodiment, control is performed to display the object group 101 such that the object group 101 does not overlap with each of the objects arranged outside the displayable area 104. However, the object group 101 may overlap with the objects not included in the object group 101. In such a case, the area in which the objects not included in the object group 101 are displayed also becomes the displayable area 104.

Further, according to the fourth and fifth exemplary embodiments, the starting portion is provided in the object group 101. However, it does not need to be provided. If the starting portion is not provided in the object group 101, one of the objects included in the object group 101 may be selected (dragged), or the object group 101C may be made movable. In the case where the object group 101 is made movable by the user selecting any of the objects therein, the arrangement of the objects that are placed outside the displayable area 104 when the user moves the object group is changed, and the shape of the object group 101 is changed. As a result, all objects included in the expanded portion in the object group 101 are displayed within the displayable area 104. In the case of the fourth exemplary embodiment, if the object group 101C is moved to the left side of the screen illustrated in FIG. 8 of the displayable area, control is performed to bend the objects (e.g., object 801 and 802) which do not fit within the displayable area 104. The working area on the display screen can thus be secured, and the objects included in the object group 101C can be displayed.

According to the third exemplary embodiment, the displayable area 104 is disposed in each of the displays 901 and 902. However, the displayable area 104 may be disposed in two or more display screens.

Further, according to the first, second, and third exemplary embodiments, the object group 101 includes two expanded portions. However, the object group may include three expanded portions. In such a case, the working area may not be sufficiently secured as compared to the first, second, third, fourth, and fifth exemplary embodiments. To solve such a problem, when the objects included in the expanded portion of the object group are placed outside the displayable area 104 when the user moves the object group 101A, the expansion direction of the expanded portion to which the objects belong to is changed to other direction. As a result, all objects included in the expanded portion can be displayed within the displayable area.

According to the present invention, the shape of the object group including the plurality of objects is changed, so that the working area on the display screen is secured, and the plurality of objects included in the object group can be displayed within the predetermined area on the display screen. As a result, the working area on the display screen can be secured, and the visibility and the operability of the plurality of objects included in the object group can be improved.

Further, it is not necessary to realize all of the above-described processes using software, and a portion or all of the processes may be realized by hardware.

### Other Embodiments

Embodiments of the present invention can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-153675 filed Jul. 9, 2012, which is hereby incorporated by reference herein in its entirety.

1. An apparatus comprising:
a moving unit configured to move an object group including a plurality of objects within a predetermined area of a display apparatus; and
a control unit configured to cause a display to display within the predetermined area, the objects included in the object group,
wherein the control unit causes the display to change a shape of the object group so that the objects displayed outside the predetermined area can be displayed within the predetermined area, in a case where one or more objects displayed within the predetermined area, are placed outside the predetermined area when the moving unit moves the object group.

2. The apparatus according to claim 1, wherein the object group includes a starting portion, a first expanded portion expanded in one direction from the starting portion, and a second expanded portion expanded from the starting portion in a different direction from the first expanded portion, and
wherein the control unit causes the display to change a shape of the object group by changing, using the starting portion as a reference, an expansion direction of an expanded portion including the objects which are placed outside the predetermined area so that the objects which are placed outside the predetermined area can be displayed within the predetermined area.

3. The apparatus according to claim 2, wherein the control unit causes the display to change a shape of the object group by changing the expansion direction of an expanded portion including the objects which are placed outside the predetermined area, to a different direction with the starting portion as a reference, so that the objects that are placed outside the predetermined area can be displayed within the predetermined area.

4. The apparatus according to claim 2, wherein the control unit causes the display to change the shape of the object group by changing the expansion direction of an expanded portion including the objects which are placed outside the predetermined area, to expand to an opposite side of the starting portion, so that the objects which are placed outside the predetermined area can be displayed within the predetermined area.

5. The apparatus according to claim 1, wherein the control unit causes the display to change the shape of an object group by rearranging the objects included in the object group.

6. The apparatus according to claim 1, wherein the control unit causes the display to change the shape of the object group so that an arrangement order of each object from the starting portion in an expanded portion including the objects which are placed outside the predetermined area, becomes the same as that before changing the shape of the object group.

7. The apparatus according to claim 1, further comprising a setting unit configured to set as the predetermined area in a display area of the display apparatus an area other than an area in which an object not included in the object group is displayed.

8. The apparatus according to claim 1, wherein the display apparatus includes a plurality of display screens
wherein the predetermined area is provided in each display screen, and
wherein the control unit performs control to change a shape of the object group at a boundary area of each display screen so that the objects placed outside the predetermined area can be displayed in a predetermined area set in each display screen.

9. The apparatus according to claim 8, wherein the object group includes a starting portion, a first expanded portion expanded in one direction from the starting portion, and a second expanded portion expanded from the starting portion in a different direction from the first expanded portion, and
wherein control is performed to change a shape of the object group by changing, with reference to the starting portion as a reference, an expansion direction of an expanded portion including the objects which are placed outside the predetermined area in a boundary area of each display screen, so that the objects which are placed outside the predetermined area can be displayed within the predetermined area.

10. An apparatus according to claim 1, further comprising:
an acquisition unit configured to acquire coordinates of the object group in the predetermined area; and
a determination unit configured to determine, based on the coordinates in the predetermined area acquired by the acquisition unit before and after the object group has been moved, whether the objects which are placed outside the predetermined area can be displayed within the predetermined area,
wherein the control unit performs, in the case where the determination unit determines that the objects which are placed outside the predetermined area cannot be displayed, control to change a shape of the object group.

11. A method comprising:
moving, in a predetermined area, an object group including a plurality of objects;
displaying an object included in the object group within the predetermined area; and
changing a shape of the object group when the object group is moved, in a case where one or more objects are placed outside the predetermined area among the objects included in the object group, so that the objects which are placed outside the predetermined area can be displayed within the predetermined area.

12. A computer-readable medium that causes a computer to implement the method of claim 11.

13. The computer-readable medium according to claim 12, wherein the object group includes a starting portion, a first expanded portion expanded in one direction from the starting portion, and a second expanded portion expanded from the starting portion in a different direction from the first expanded portion, and
wherein a shape of the object group is changed, using the starting portion as a reference, by changing an expansion direction of an expanded portion including the objects which are placed outside the predetermined area so that the objects which are placed outside the predetermined area can be displayed within the predetermined area.

14. The computer-readable medium according to claim 13, wherein a shape of the object group is changed by changing the expansion direction of an expanded portion including the objects which are placed outside the predetermined area, to a different direction with the starting portion as a reference, so that the objects that are placed outside the predetermined area can be displayed within the predetermined area.

15. The computer-readable medium according to claim 13, wherein the shape of the object group is changed by changing the expansion direction of an expanded portion including the objects which are placed outside the predetermined area, to expand to an opposite side of the starting portion, so that the objects which are placed outside the predetermined area can be displayed within the predetermined area.

16. The computer-readable medium according to claim 12, wherein the shape of an object group is changed by rearranging the objects included in the object group.

17. The computer-readable medium according to claim 12, wherein the shape of the object group is changed so that an arrangement order of each object from the starting portion in an expanded portion including the objects which are placed outside the predetermined area, becomes the same as that before changing the shape of the object group.

18. The computer-readable medium according to claim 12, further comprising setting as the predetermined area in a display area of the display apparatus an area other than an area in which an object not included in the object group is displayed.

19. The computer-readable medium according to claim 12, wherein the display apparatus includes a plurality of display screens
wherein the predetermined area is provided in each display screen, and
wherein a shape of the object group is changed at a boundary area of each display screen so that the objects placed outside the predetermined area can be displayed in a predetermined area set in each display screen.

20. The computer-readable medium according to claim 19, wherein the object group includes a starting portion, a first expanded portion expanded in one direction from the starting portion, and a second expanded portion expanded from the starting portion in a different direction from the first expanded portion, and
wherein a shape of the object group is changed by changing, with reference to the starting portion as a reference, an expansion direction of an expanded portion including the objects which are placed outside the predetermined area in a boundary area of each display screen, so that the objects which are placed outside the predetermined area can be displayed within the predetermined area.
